(19) United States
(12) Patent Application Publication
(10) Pub. No.: US 2024/0141865 A1
(43) Pub. Date: May 2, 2024

(54) POWER PLANT

(71) Applicant: Erik SVENSSON, Skövde (SE)

(72) Inventor: Erik SVENSSON, Skövde (SE)

(21) Appl. No.: 18/278,699

(22) PCT Filed: Feb. 24, 2022
(86) PCT No.: PCT/SE2022/050193

§ 371 Date: Aug. 24, 2023

(30) Foreign Application Priority Data
Feb. 24, 2021 (SE) 2150195-2

(51) Int. Cl. F03B 13/26; F03B 17/06

(52) U.S. Cl. CPC F03B 13/264; F03B 17/061; F05B 2240/95

(57) ABSTRACT

A power plant (10) comprising: a substantially tubular body configured to be arranged submerged when in operation, the body comprising: an inlet (13, 13); a substantially tubular portion (11) extending in a first direction, and a portion (12) connected to the substantially tubular portion (11) and having an outlet (14), which has a greater diameter than the inlet (13, 13′). The power plant further comprises a turbine (15) arranged in the substantially tubular portion (11) and configured to be connected to a generator (16), and the tubular portion (11) and the outlet (14) are configured to be positioned in a substantially vertical direction with respect to a water surface (25) when submerged.

### TECHNICAL FIELD

The present invention relates to power plants for conversion of kinetic and potential fluid energy of, e.g., sea water into electrical energy or similar.

### BACKGROUND

Wave and tide (or streaming water) energy is the transport and capture of energy by ocean surface waves or submerged convertors the kinetic energy of the water. The energy captured can be used for different types of useful work, including electricity generation, water desalination and pumping of water. Wave energy is thus a renewable energy and is the largest estimated global resource form of ocean energy.

Systems for capturing surface wave energy are known. These systems, comprising floating portion or float, can be vertically oscillated in response to passing waves. The float may be coupled to an energy converter, which is driven in response to vertical movements of the float.

There are several variants of wave power plants and there are also tidal power plants: Oscillating buoy plant, for example, has a low power per unit and an uneven power curve over the period. The effect in such a plant has a linear relationship to the plant's dead weight and wave height (double mass or wave height results in double effect).

Existing comparable tidal power plant may be compared to a wind turbine located on the seabed. The disadvantage of these is that the energy per square meter in flowing water may be low and that this type of turbine has a low efficiency (less than 50%; theoretically a maximum of about 60%). These are expensive to manufacture, and they also have an open rotor, which can be dangerous for animals. Another disadvantage may be that the applied force must be counteracted using a large foundation on the sea bottom/seabed to prevent the plant from tipping over.

GB 1573334 relates to the field of generation of power by positioning a power-generating mechanism in ocean current or other flowing water for the purpose of causing the flow of current to drive a plurality of vanes, thus producing mechanical work and converting the mechanical work into electrical, mechanical, hydraulic or other type power capable of being stored and used. The power-generating mechanism of this invention is designed for flowing water currents and configured to be arranged in the flow direction, i.e. the inlet and the outlet are arranged parallel to water flow direction.

### SUMMARY

Thus, one object of the present invention is to provide an efficient energy conversion arrangement for converting kinetic or potential energy of water (or other fluids) to another type of energy, such as electrical energy, impetus energy or movement. Another object of the present invention is to provide an arrangement to convert both wave and/or streaming water motion to energy. Yet another object of the present invention is to use an energy converter or parts of it for oxygenate seabed.

According to the present invention, there are no direct relationship between the power plant's dead weight and the wave height, because the effect is in relation to the wave height and volume flow. The invention allows adjusting the volume flow to the amount of water available in the current wave. This provides the opportunity to construct significantly larger units in terms of power than, e.g., buoy solutions. The plants according to the present invention may produce megawatts of continuous power compared to less than 100 kW peak power, which may be the case for oscillating buoy. In addition, these may contribute with swing mass to the electricity grid. One reason is that the power plant of the present invention can convert a much larger portion of the wave's energy (higher efficiency per square meter wave surface), and the powerplant can be built with a larger receiving area (more square meters)

Various embodiments of the power plant according to the present invention have relatively low numbers of moving parts and are constructed to be situated substantially under the sea surface during operation. According to one embodiment, the plant of the invention is arranged to exploit pressure changes along a horizontal line below the sea water-surface due to moving waves to generate flow in a tube and to convert this flow into usable energy.

Sucking the water into a pipe allows to determine the flow rate over the turbine. It is possible to allow the flow velocity over the turbine be higher than the velocity of the free-flowing water as long as the outlet velocity is lower than the flow velocity of the free water (if the velocity over the turbine is doubled, it may be possible to convert twice as much energy as the volume flow becomes twice as large, while volume in cubic meter is constant). In addition, a tubular turbine with a draft tube has a significantly higher efficiency (over 90%). Moreover, it is possible to encapsulate the turbine, which makes it all safer for larger aquatic animals. At the inlet, a so-called grate or guard may be placed, which prevents larger objects from being sucked into the turbine.

Moreover, the force components become rotation around the turbine shaft and thus a pressure vertical direction (if the turbine is arranged vertical). These forces can be absorbed by means of buoyancy and a wing shape that makes the plant in line with the direction of the water flow. This allows constructing floating units that are easier to moor and allow constructing in much greater depths.

For these reasons a power plant is provided, comprising: a substantially tubular body configured to be arranged submerged when in operation. The body comprises: an inlet; a tubular portion extending in a first direction, and a portion connected to said tubular portion and having an outlet, which has a greater diameter than the inlet. The plant further comprises a turbine arranged in the substantially tubular portion and configured to be connected to a generator. The tubular portion and the outlet are configured to be positioned in a substantially vertical direction with respect to a water surface when submerged. In one embodiment, the substantially tubular extension extends in a second direction with respect to the substantially tubular portion and is configured to be in line with a mean water level when the power plant is submerged. In one embodiment, the substantially tubular extension extends over an entire wavelength or is at least longer than half wavelength. In one embodiment, the power plant further comprises one several inlets along a longitudinal axis of the tubular extension. Thus, the one or several inlets may be arranged in an angle α, with respect to the tubular extension, wherein a 90 degrees. In one embodiment, the inlets when exposed to a high-water pressure, allow water into the substantially tubular portion and the turbine. The power plant may comprise a directing arrangement for directing the inlet. In one embodiment, the power plant is a floating plant and moored with at least one slack mooring and a slip ring. According to one embodiment, the power plant may be configured to be made fast to a number of foundations on the seabed. The power plant may be configured to be arranged at an angle to a wave direction. In yet another embodiment the power plant may be configured to be positioned close to land where a wave direction is more equal. According to one embodiment, the power plant may be configured to be turned such that it avoids ending up in line with, or vertical to a wave front. In one embodiment, the inlets may be configured to be close, but constantly below a mean water level when submerged. In yet another embodiment, the extension portion may be made of steel or a rigid material, and an inlet's height is adapted to a prevailing wave situation by raising and lowering the entire power plant. The power plant may comprise flexible inlet that floats and follows a wave motion when in operation. The power plant may be configured to be floating and follow a wave direction, and the entire power plant is arranged rotatable. According to one embodiment, the power plant may comprise fins under the inlet pipe and the plant is configured to be positioned in a predetermined angle to the wave direction. The fins may be configured adjustable to allow optimizing the angle to a wave front and to be able to compensate for any overlying water currents with a direction other than the direction of the waves. In one embodiment, a gear ring may be arranged on the slip ring with a motor on the power plant that configured to turn the plant using the gear ring. The power plant may comprise propellers, which arranged at a far end of the tubular extension. Preferably a depth (d₀) of the outlet is d₀ ¼ wavelength of a dimensioning wave. However, if do depth is not achievable or sea depth is not sufficient, the outlet is arranged as close as possible to the sea bottom, preferably in less than 2 meters from sea bottom.

The power plant of the present invention may also be used for oxygenating seabed.

### BRIEF DESCRIPTION OF THE DRAWINGS

Reference is made to the attached drawings, wherein elements having the same reference number designation may represent like elements throughout.

FIG. 1 is a diagram of an exemplary system according to basic idea of the invention;

FIG. 2 illustrates schematically, a first exemplary embodiment of the invention;

FIG. 3 is schematic view of a second exemplary embodiment of the invention; and

FIG. 4 is schematic view of another exemplary embodiment of the invention.

### DETAILED DESCRIPTION

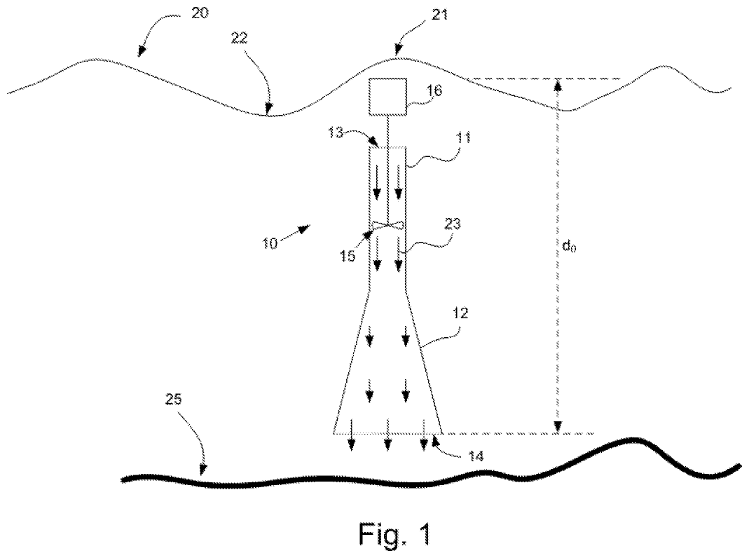

The basic principle of the present invention is illustrated in FIG. 1:

If a flow generator device 10 comprising a substantially cylindrical pipe 11 with an inlet 13 connected to a substantially conical portion 12 with an outlet 14 is placed substantially vertically, according to this example, under water above the seabed 25 with the upper inlet 13 close to but below the water surface 20 and the lower opening (outlet) 14 (diameter of outlet 14>diameter of inlet 13) at a depth where a pressure variations between a wave peak 21 and a wave valley 22 are significantly lower than at the inlet 13, a flow 23 is created in the flow generator device 10 when a wave peak 21 or a wave valley 22 passes over the device. This is due to that the pressure at the inlet varies with the wave while the pressure at the lower outlet is relatively constant. If the lower portion is provided with a draft tube (conical portion) 12, where a flow energy is converted to a pressure according to Bernoulli's equation, the flow rate at the downward water flow will be higher than for the upward flowing water. This is due to that the pressure drop across the pipe is in proportion to the pressure difference between the two openings (inlet, outlet). With downward flowing water, the flow will be less turbulent, implying that the friction losses decrease, and the flow rate increases. In addition, the downwardly flowing water has a flow rate even before it is sucked or carried into the pipe, which further increases the flow rate in the pipe.

By arranging a turbine 15 (or similar) connected to a generator 16 in a suitable position in the substantially cylindrical pipe 11, a powerplant is provided. In operation, the turbine 15, comprising turbine blades, is actuated by the flowing water 23 through the pipe 11 and rotates, resulting in the rotation of the generator's 16 shaft, which generates electrical power in a well-known manner. This powerplant primarily generates electricity when wave tops pass the inlet. When wave valleys pass the inlet, the turbine might be set to run backwards resulting in power generation at much lower efficiency.

The inlet may be arranged below or in line with the mean or average water level. It may be situated constantly below the water surface to prevent changes in the plant's flow properties. For the sake of functionality, it does not matter if the inlet is above the surface at the wave valley.

The illustrated and described vertical positioning is not necessary as long as the inlet is under the surface and the outlet in a sufficient deep.

The powerplant may anchored and fixated to a foundation at the seabed but preferably floating, anchored with slack mooring (not shown but further described below). The inlet should be located as close to the water surface as possible in order to maximize the pressure difference between inlet and outlet. Therefor it might be an advantage to have the powerplant floating, following the wave surface.

Another possible area of use for such a system may be airing and/or oxygenation of the seabed 25. The lower opening 14 may then be placed close to the seabed 25. An alternative to completely prevent the upward water flow may be to place a non-return valve in a suitable position in the pipe.

The depth of the outlet 14 is designated with do, which indicates a distance substantially from the mean water level to the outlet 14. Preferably, the depth (do) of the outlet is d₀≥¼ wavelength of a wave which is used to dimension the plant. The dimensioning of the plant with respect to a wave may be carried out before installation of the plant and with respect to average wavelength of the location obtained from wavelength data, as described further below. This implies that if the wavelength for dimensioning wave is x m, the depth (from water surface) to the outlet will be x/4 m. In some locations, if do depth is not achievable or sea depth is not sufficient, the outlet can be arranged as close as possible to the sea bottom. Preferably, the distance may be less than 2 meters. In one embodiment do may be 20m≤d₀≤30m and in particular approximately 25 meters.

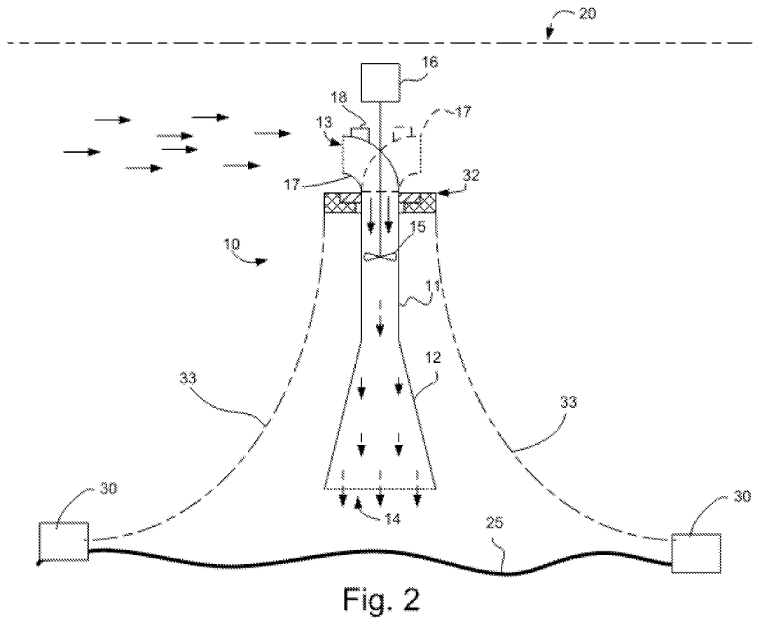

According to a second aspect of the invention, the previously described basic concept is further developed as illustrated in the exemplary embodiments of in FIGS. 2 to 4.

In the embodiment of FIG. 2, especially useful for tide or streaming water applications, the flow generating device 10, comprising the pipe 11 and the conical portion 12, the turbine 15 connected to the generator 16, and the inlet section with the inlet 13 is extended with a partially horizontal extension 17 (substantially not same direction as tube 11).

This system may be better suited for the conversion of flowing water (tides, ocean currents, rivers, etc.) to electrical energy. In one embodiment the inlet section 17 may be arranged rotatable around its centre axis, in this example in a vertical direction, to be directed towards the water stream. In this case a vane 18 mechanism, functioning in same way as a wind vane may be used. Also, more complex, automated and computer-controlled direction controls may be used. In one embodiment, the entire plant may be arranged rotatable such that the inlet is directed towards the water stream. However, the inlet does not need to be directed towards the water stream, but the efficiency may increase as the turbulence at the inlet may decrease.

The turbine 15 should not be too close to the surface as there is a risk of cavitation due to the low pressure after the turbine's position. In one advantageous embodiment, the turbine is positioned just before the beginning of the draft tube. However, the turbine can be positioned anywhere along the pipe 11 as long as it is above the cavitation pressure point.

The generator 16 may be submerged or arranged floating on the sea surface.

In one embodiment, initially, the turbine 15 may be started as a pump to initiate a flow in the system. When the flow rate in the inlet pipe is as high as the tidal current, the turbine does not accelerate water. Instead, it is the draft tube that creates a negative pressure following the turbine that drives the flow. At the draft tube's 12 outlet 14, the flow rate is low and the pressure is as large as the ambient pressure. At the inlet 13, the flow rate is higher and the pressure is as big as the ambient pressure. Consequently, the kinetic energy of the water in the system is converted to the pressure in the draft tube, to the torque of the turbine, rotate the generator and generate electricity. The inlet can but does not have to be directed towards the flowing water.

According to this embodiment, the plant 10 is moored to a number of foundations 30, e.g., made of concrete, on the seabed 25 using slack moorings 33, comprising of, e.g., chains, rope, cord, etc. Same or similar fixation principal may be applied to the exemplary embodiment of FIG. 1.

In this embodiment, the entire plant may also rotate (e.g., if pipe 17′ is fixed), e.g., around the turbine housing (turbine axis) using a flexible (slip) ring 32 that is moored with the slack moorings 33, for example in three points. One way to achieve the rotation is to arrange fins 18 under the inlet pipe 17 such that the plant is positioned in a predetermined angle to the wave direction (similar to a wind vane). Optionally, the fins can be adjustable to allow optimizing the angle to the wave front and to be able to compensate for any overlying water currents with a direction other than the direction of the waves. The fins may also be arranged along the tubular section 11, or any other part exposed to the water force.

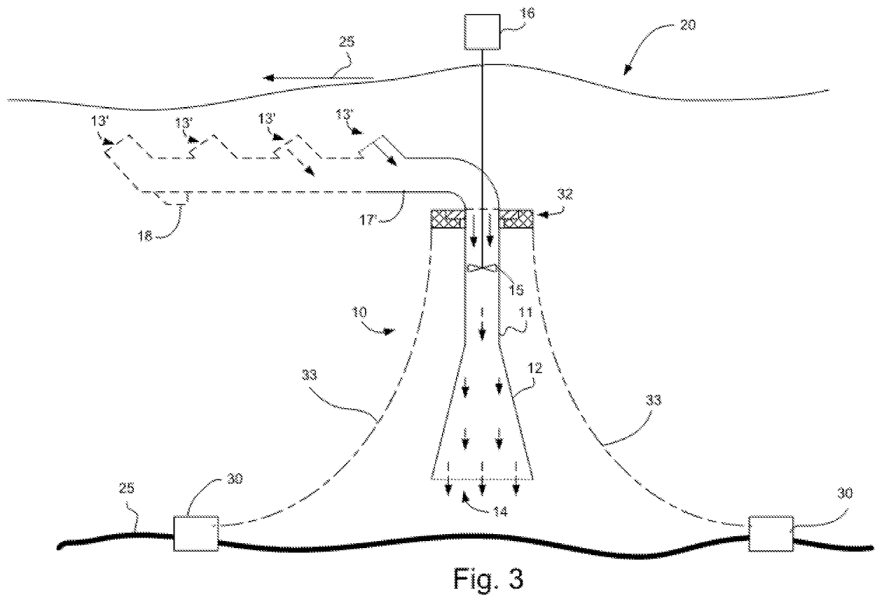

According to another aspect of the invention, the previously described concept is yet further developed as illustrated in the exemplary embodiment of in FIG. 3.

The plant 10 according to this embodiment is provided with an inlet tube 17′ comprising a number of inlets 13′. Each inlet 13′ extends from the horizontal axis of the inlet tube 17′ in an angle α, α≤90°, in the direction of the sea surface 20. The inlet tube 17′ optimally extends over an entire wavelength and the inlet or inlets that are exposed to the highest pressure allow water into the tube and towards the turbine 15. Consequently, the system generates electricity continuously due to wave movement. This system is based on the same principles as a traditional hydropower plant, but the hydropower dam is substituted by wave crests. In this case the initial kinetic energy of the water may as well be converted to energy by the turbine.

The inlets 13′, according to this exemplary embodiment, are illustrated arranged on the upper side of the pipe 17′ with inlets relatively parallel to the wave surface, because an opening near the wave surface is desired and as much of the plant as possible is underwater. The inlets may be arranged and formed in several different ways. In one embodiment, the inlets can be arranged throughout and surrounding of the entire pipe 17 having different angles. It is also conceivable that the pipe has a large opening along the top so that it builds a channel-shaped inlet. It may be advantageous if the inlet is in line with the mean water level. This may be suitable for a submerged plant, close to the seabed.

If inlets 13′ are oriented upward, a good result may be achieved if the pipe 17′ is not drained or possible air pockets are not created at the inlet, if the inlet is exposed to air when exposed to a wave valley. This means that the inlets should be exposed to water substantially continuously. This may be valid for all embodiments.

Also, this embodiment is moored to a number of foundations 30, on the seabed 25 using slack moorings 33. Thus, the entire plant can rotate around the turbine housing, by means of the slip ring 32 moored with slack moorings 33 allowing the plant to rotate.

The floating plants with only one inlet (which do not have to be directed to a wave direction) may be moored with at least one slack mooring, as illustrated in FIG. 3. This allows significantly lower anchoring forces than tensile mooring because the plant has a flexibility in the waves.

For a floating plant that needs to follow the wave direction, there may be several embodiments:
In one embodiment, a gear ring may be arranged on the slip ring with a motor on the plant that operates turning of the plant using the gear ring. In one embodiment, the plant may be turned with propellers, which may be arranged at the far end of the arms (tube 17) to provide the best lever.
In one embodiment an electrical anchor can be used for mooring and/or rotation.
A combination of the embodiments may also exist.

Advantages of having a mooring slip ring in three positions may be that the position of the plant can be determined and risk of tangling the connecting cables in the anchorage is eliminated.

In an alternative embodiment, to avoid rotating the plant, the plant may have two or more inlet tubes in different directions.

The inlet pipe's 17′ length extends optimally over an entire wavelength but with an angle facing the wave front to capture a wide wave front. Optimal extension over at least one wavelength ensures that at least one inlet can be under a wave peak. The wave motion is indicated with arrow 25. This allows for a largest possible energy absorption than if the inlets were in line with the wave movement. The inlet pipe 17′ takes in water via an inlet 13′ where it is exposed to the highest pressure. Non-return valves may be located at the inlets to prevent water from penetrating out into the wave valleys. The inlets are located below but near the water surface (below a mean water level). The inlet pipe may be branched.

Wave data including wavelengths (actual, average and estimated) for different coastal areas may be available in different databases, such as ESA's GlobWave project, North Sea Wave Database, National Oceanographic Database (NODB), etc. Based on this data, length of the inlet pipe (17, 17′) can be determined. When installing a power plant, according to the present invention, data for wavelength of the area is acquired and based on the wavelength data, the length of the inlet pipe 17′/17 is adjusted. The length may be chosen from ready build set of pipes or by cutting or adding a section of the pipe. In one embodiment the pipe may comprise a telescopic section, length of which can be controlled by a motor, which may also comprise a controller that receives signals about the wavelength from a control station to adjust the length of the pipe 17′/17 to current wavelength.

The entire plant 10 or the pipe 17″ may be rotated by means of one or several vanes or fins 18.

The turbine 15 may be in form of a tubular turbine with high efficiency at low drop heights. The generator 16 determines the speed of the turbine 15 and converts the torque to electricity. The turbine may be a Kaplan turbine with an efficiency of over 90% at low drop heights, or any other suitable turbines. The flow rate through the turbine 15 is determined by the speed and may increase advantageously when the wave height increases. This gives a power curve that increases exponentially with the wave height, as the energy of the wave also increases exponentially with the wave height.

The actual flow rate and flow direction over the turbine may be determined by setting the speed of the generator. Of course, it is conceivable to reverse the turbine, but a draft tube may be installed at each end of the system, which may work in the embodiment with one inlet.

As mentioned earlier, the function of the draft tube 12 is to increase the pressure drop across the turbine by converting the kinetic energy of the water into pressure. At the outlet, the flow rate is low and the pressure in the pipe is as great as the pressure outside the pipe. The flow rate before the draft tube is higher and the pressure before the draft tube is thus lower than the pressure outside the pipe at the same depth.

The initial kinetic energy of the water, which depends on the kinetic energy of the wave and/or other water currents (tides, etc.) may also be converted to energy because of the draft tube.

In the case of wave plants, the outlet 14 may be placed at a depth where the pressure variations are small in relation to the variations near the surface. The inlet may be arranged below or in line with the mean water level.

During the operation, the pressure difference between the inlet 13/13′ and outlet 14 is theoretically optimally half a wave height and the outlet velocity lower than the flow velocity at the inlet. This means that the turbine converts both pressure and kinetic energy with the help of the draft tube 12, which means that part of the kinetic part of the wave is converted as well as any other (ocean) currents such as tidal currents. The velocity of the water in the inlet may probably be higher than the velocity of the free water. This may be used to reduce the dimensions of the pipes, etc.

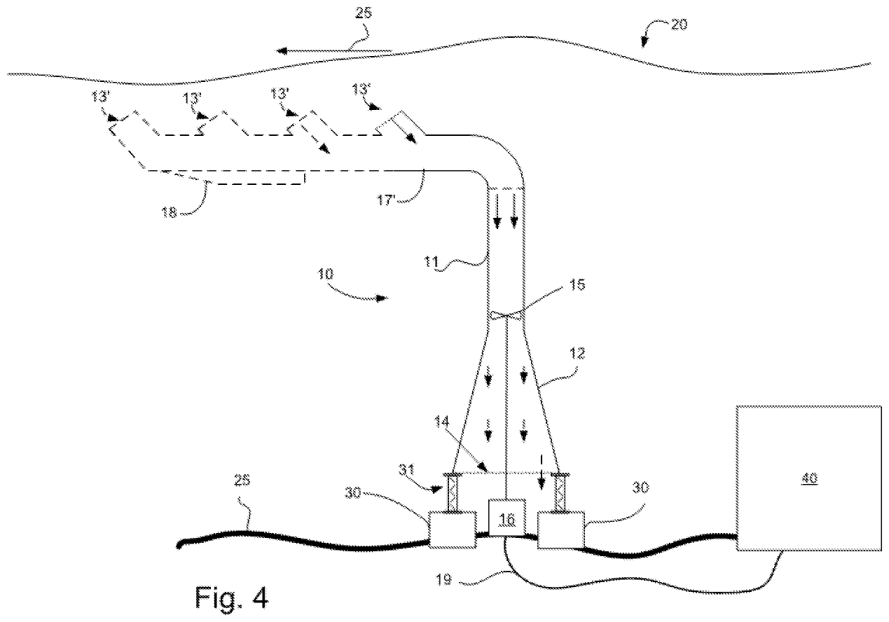

FIG. 4 illustrates another exemplary embodiment of the invention in which the generator 15 is arranged beneath the outlet 14, outside the draft tube 12. The generator 16 is connected to a storing and/or transformation station 40 by means of a cable 19.

To obtain the best effect, the power plant needs to be arranged at an angle to the wave motion to capture a large wave front, but it must not be arranged vertically towards the wave motion because it will then act as a point absorber, i.e., absorbing energy from all directions through its movements at/near the water surface. The location of the plant can be close to land where the wave direction is more similar because the waves turn up towards land when shallowing. Another alternative may be to turn the plant or pipe 17′, such that it avoids ending up in line with, or vertical to the wave front.

The pressure difference that is created between the wave peak and wave valley decreases rapidly with depth. In order to achieve as high-pressure difference as possible between the inlet and the outlet, it is therefore important that the inlets are close (but constantly below) the surface. Since small waves have shallower valleys, it is therefore possible that the inlet is shallower when the waves are small and deeper when the waves are bigger. If the inlet pipes are made of steel or other rigid material, it is therefore conceivable that the inlet height is adapted to the prevailing wave situation by raising and lowering the entire power plant, like a submarine. An alternative can be flexible inlets that floats following the wave motions.

The plant 10 as illustrated in FIG. 4 is anchored to a number of foundations 30, e.g., made of concrete, on the seabed 25 using moors 31, such as chains, piles, columns, etc. and does not have to turn with the waves.

All embodiments illustrated in FIGS. 2-4, may also be used for oxygenation of the seabed 25 as the lower outlets 14 can be placed close to the seabed.

Additional embodiments are possible:

It is possible that two or more plants are connected into larger units.

It is conceivable to turn the entire structure and have the outlet upwards (takes water in deep water (peak) and releases it into the wave valleys). This may be reasonable in an arrangement with an inlet and outlet point (not for continuous flow over the turbine).

In one embodiment, the turbine blades may change direction to allow rotation due to the backflow. This may be relevant for wave power plants with one inlet point, which does not provide continuous flow.

Inlets 13 or 13′ can be arranged with bars or grates, which prevents larger objects from being sucked into the turbine.

It should be noted that the word “comprising” does not exclude the presence of other elements or steps than those listed and the words “a” or “an” preceding an element do not exclude the presence of a plurality of such elements. It should further be noted that any reference signs do not limit the scope of the claims.

The foregoing description of embodiments of the present invention, have been presented for purposes of illustration and description. The foregoing description is not intended to be exhaustive or to limit embodiments of the present invention to the precise form disclosed, and modifications and variations are possible in light of the above teachings or may be acquired from practice of various embodiments of the present invention. The embodiments discussed herein were chosen and described in order to explain the principles and the nature of various embodiments of the present invention and its practical application to enable one skilled in the art to utilize the present invention in various embodiments and with various modifications as are suited to the particular use contemplated. The features of the embodiments described herein may be combined in all possible combinations of methods, apparatus, modules, systems, and computer program products.

1. A power plant comprising:
a substantially tubular body configured to be arranged submerged when in operation, the body comprising:
an inlet;
a substantially tubular portion extending in a first direction, and
a portion connected to the substantially tubular portion and having an outlet, which has a greater diameter than the inlet,
wherein:
arrangements configured to anchor the power plant to sea bead when submerged;
the inlet configured to receive water due to pressure changes along a horizontal line below the sea water-surface to generate flow in the tubular portion;
a turbine arranged in the substantially tubular portion and configured to be connected to a generator, and
the substantially tubular portion and the portion are configured to be positioned in a substantially vertical direction with respect to a water surface when submerged, and in communication with the substantially tubular portion further comprising a substantially tubular extension, comprising one or several inlets along its longitudinal axis in line with a mean water level, and extending in a second substantially perpendicular direction with respect to the substantially tubular portion.

2. (canceled)

3. The power plant of claim 1, wherein the substantially tubular extension extends over an entire wavelength or is at least longer than half wavelength.

4. (canceled)

5. The power plant of claim 1, wherein one or several inlets are arranged in an angle α, with respect to the tubular extension, wherein α≤90 degrees.

6. The power plant according to claim 1, wherein the inlets when exposed to a high-water pressure, allow water into the substantially tubular portion and the turbine.

7. The power plant according to claim 1, comprising a directing arrangement for directing the inlet.

8. The power plant according to claim 1, wherein the power plant is a floating plant and moored with at least one slack mooring and a slip ring.

9. The power plant according to claim 1, wherein the power plant is configured to be:
made fixed to a number of foundations on a seabed, and/or
arranged at an angle to a wave direction, and/or
positioned close to land where a wave direction is more equal, and/or
turned such that it avoids ending up in line with, or vertical to a wave front, and/or
floating and follow a wave direction, and the entire power plant is arranged rotatable.

10. The power plant according to claim 1, wherein the inlet is configured to be adjacent to, but constantly below a mean water level when submerged.

11. (canceled)

12. The power plant according to claim 1, wherein the power plant comprises inlet that floats and follows a wave motion when in operation.

13. The power plant according to claim 12, wherein the power plant comprises fins under the tubular extension and the plant is configured to be positioned in a predetermined angle to the wave direction.

14. The power plant according to claim 12, wherein the fins are configured adjustable to allow optimizing the angle to a wave front and to be able to compensate for any overlying water currents with a direction other than the direction of the waves.

15. The power plant according to claim 8, wherein a gear ring is arranged on the slip ring with a motor on the power plant that configured to turn the plant using the gear ring.

16. The power plant according to claim 1, comprising propellers, which propeller is arranged at a far end of the tubular extension.

17. The power plant according to claim 1, wherein a depth, d₀, of the outlet is d₀≥¼ wavelength of a dimensioning wave.

18. The power plant according to claim 17, wherein if the depth of the outlet is not achievable or sea depth is not sufficient, the outlet is arranged as close as possible to the sea bottom, preferably in less than 2 meters from sea bottom.

19. Use of a power plant according to claim 1 for oxygenating seabed by placing the outlet close to the seabed and providing water flow from inlet close to sea-eater surface to outlet.
